(19) United States
(12) Patent Application Publication
(10) Pub. No.: US 2021/0390473 A1
(43) Pub. Date: Dec. 16, 2021

(54) EVALUATION METHOD AND SYSTEM OF ENTERPRISE COMPETITION BARRIERS

(71) Applicant: INNO MANAGEMENT CONSULTATION (BEIJING) LTD., Beijing (CN)

(72) Inventor: Xijun CAO, Beijing (CN)

(21) Appl. No.: 17/279,633

(22) PCT Filed: Sep. 20, 2019
(86) PCT No.: PCT/CN2019/106996

§ 371 Date: Mar. 25, 2021

(30) Foreign Application Priority Data
Sep. 30, 2018 (CN) 201811161745.0

(51) Int. Cl. G06Q 10/06; G06Q 30/02; G06N 20/00; G06Q 10/04

(52) U.S. Cl. CPC G06Q 10/0637; G06Q 30/0202; G06Q 10/04; G06N 20/00; G06Q 30/0201

(57) ABSTRACT

Disclosed is a method for evaluating enterprise competition barriers, including a step of obtaining enterprise data, which obtains data related to enterprise competition barriers; a step of evaluating enterprise competition barriers, which evaluates competition barriers of an enterprise to be evaluated from multiple dimensions based on an evaluation model and factors acquired in advance, so as to obtain an evaluation value of competition barriers of the enterprise to be evaluated; and a step of outputting barrier evaluation result, which outputs the evaluation value of competition barriers of the enterprise to be evaluated. The disclosure also provides an enterprise competition barrier evaluation system. By using the method and system for evaluating enterprise competition barriers of the present disclosure, the enterprise competition barriers can be quantitatively evaluated, which can be used for self-examination and management decision-making of the enterprise itself, and can also be used for investment decision-making of investors.

### TECHNICAL FIELD

The disclosure belongs to the technical field of data analysis, and relates to an enterprise value evaluation method and system, in particular to a quantitative evaluation method and system for enterprise competition barriers.

### BACKGROUND OF THE DISCLOSURE

In the development of mankind to this day, continuous innovation is a fundamental means for the development of a country or economic entity. Many innovations need to be realized through the establishment of enterprises. In other words, innovation and entrepreneurship are inseparable, and entrepreneurship is an extension and implementation of innovation. At this stage, many enterprises have emerged in the atmosphere of innovation and entrepreneurship, but the survival rate of most start-ups is extremely low. Staring a new business is a narrow escape from death. One of fundamental reasons for the failure of start-ups is that they failed to timely and effectively construct barriers to competition in an all-round way in their own fields, and to continuously consolidate and upgrade barriers to competition.

Startups may have certain advantages in a certain aspect when they were able to survive, but if they do not fully highlight the advantages in that aspect in time to form barriers and constantly overcome other disadvantages to build a full range of barriers, it will eventually be difficult to survive in the fierce market. Entrepreneurs need to consciously discover their own advantages in one dimension and their disadvantages in other dimensions, so as to adjust and optimize them in time to make the enterprise bigger and stronger. Investors face entrepreneurial projects displayed by entrepreneurs, in addition to examining the innovation, feasibility, social value, and market potential of the business model, it is more practical to examine the barriers of the entrepreneurial project itself. Because projects without barriers are easy to be imitated and surpassed, the original projects are easy to fail and become martyrs. Investing in projects with no barriers will lead to investment failure with a high probability. Therefore, for investors, and even entrepreneurs, a certain degree of quantitative evaluation of the target enterprise's barriers to competition is of extraordinary practical significance.

There are various enterprise value evaluation methods or systems in the prior art, but there is no method or system for quantitatively evaluating the competition barriers of enterprises.

### SUMMARY OF THE DISCLOSURE

In order to solve the above-mentioned problems, the present disclosure proposes a method for evaluating enterprise competition barriers, which comprises: a step of obtaining enterprise data, which obtains data related to enterprise competition barriers; and a step of evaluating enterprise competition barriers, which evaluates competition barriers of an enterprise to be evaluated from multiple dimensions based on an evaluation model and factors acquired in advance, so as to obtain an evaluation value of competition barriers of the enterprise to be evaluated; and a step of outputting barrier evaluation result, which outputs the evaluation value of competition barriers of the enterprise to be evaluated.

In the method for evaluating enterprise competition barriers of the present disclosure, preferably, the data related to enterprise competition barriers include at least: technical barrier data, team barrier data, business capability barrier data, value chain integration capability barrier data, financing capability barrier data, and goodwill and brand barrier data, the factors include a technical barrier factor, a team barrier factor, a business capability barrier factor, a value chain integration capability barrier factor, a financing capability barrier factor, and a goodwill and brand barrier factor.

In the method for evaluating enterprise competition barriers of the present disclosure, preferably, the technical barrier data include at least the number of intellectual properties owned by the enterprise and market value of each intellectual property, and the market value of each intellectual property involves domestic potential market and foreign potential market.

In the method for evaluating enterprise competition barriers of the present disclosure, preferably, the number of intellectual properties includes the number of granted and/or pending invention applications, utility model applications, design applications, and copyright applications.

In the method for evaluating enterprise competition barriers of the present disclosure, it is preferable that the technical barrier data further includes the number of technical secrets owned by the enterprise and a resulting market value.

In the method for evaluating enterprise competition barriers of the present disclosure, preferably, the team barrier data include at least one or more of enterprise equity structure data, partner complementarity data, project-competence matching degree data, team innovation power data, team execution force data, and team learning power data, the team learning power data include team learning awareness data and learning ability data, and the team innovation power data include team innovation awareness data and innovation ability data.

In the method for evaluating enterprise competition barriers of the present disclosure, preferably, the business capability barrier data include at least one or more of special product production capability data, hardware manufacturing capability data, software development capability data, and cost control capability data.

In the method for evaluating enterprise competition barriers of the present disclosure, preferably, the value chain integration capability barrier data include at least one or more of purchasing capability data, marketing capability data, channel operation capability data, network influence expansion capability data, and enterprise public relations capability data.

In the method for evaluating enterprise competition barriers of the present disclosure, preferably, the financing capability barrier data include at least financial profitability data, business plan promotion capability data, data on the breadth of financing channels, data on the ability to interact with investors, and data on the value of intangible assets.

In the method for evaluating enterprise competition barriers of the present disclosure, preferably, the goodwill and brand barrier data include at least brand-related trademark quantity data, trademark status data, trademark use time data, trademark spreading difficulty data, and main website influence data and data on the number of registered users.

In the method for evaluating enterprise competition barriers of the present disclosure, preferably, the barrier data further includes enterprise cultural barrier data and enterprise value (orientation) barrier data.

In the method for evaluating enterprise competition barriers of the present disclosure, preferably, in the step of obtaining enterprise data, a user directly enters data related to competition barriers of the enterprise to be evaluated, or an evaluation server uses big data to capture public data shared by the enterprise through the internet based on a brand, name, or unified social credit code entered by a user.

In the method for evaluating enterprise competition barriers of the present disclosure, it is preferable that the evaluation model and/or each factor are preset according to a development stage of the enterprise and an industry to which it belongs, and adjusted artificially according to a result of statistical analysis, or optimized based on artificial intelligence.

In the method for evaluating enterprise competition barriers of the present disclosure, preferably, each factor is set in advance as a weight coefficient of competition barrier-related data of each dimension, and a weighted sum of the competition barrier-related data of all dimensions is calculated as the evaluation value of competition barriers of the enterprise.

In the method for evaluating enterprise competition barriers of the present disclosure, it is preferable that an artificial intelligence algorithm with a learning function is used to generate and continuously optimize the evaluation model and a combination of the factors through machine learning or deep learning based on successful cases in different industries and previous evaluation results.

In the method for evaluating enterprise competition barriers of the present disclosure, it is preferable that an algorithm for generating the evaluation model and/or an algorithm for generating the factors are optimized through machine learning or deep learning based on successful cases in different industries and previous evaluation results.

In the method for evaluating enterprise competition barriers of the present disclosure, it is preferable that an artificial intelligence algorithm with a learning function is used to delete barrier data from or add new types of barrier to one or more of the technical barrier data, the team barrier data, the business capability barrier data, the value chain integration capability barrier data, the financing capability barrier data, and the goodwill and brand barrier data, through machine learning or deep learning based on successful cases in different industries and/or previous evaluation results.

Embodiments of the present disclosure also provide an enterprise competition barrier evaluation system, which uses the above-mentioned enterprise competition barrier evaluation method to evaluate the enterprise competition barrier, including a client, a database, and a server, wherein the database has: an evaluation model database, which stores evaluation models for enterprise competition barriers; and a factor database, which stores factors of various parameters related to enterprise competition barriers, and the factors are grouped into a set of factors. The server has: an enterprise data receiving unit that receives enterprise information or enterprise data input by a user from the client; an enterprise competition barrier evaluation value calculation unit that retrieves a corresponding evaluation model stored in the evaluation model database, and calculates an evaluation value of competition barriers of the enterprise to be evaluated based on the data related to the competition barrier of the enterprise received by the enterprise data receiving unit and the factors stored in the factor database; and an evaluation value output unit, which outputs the evaluation value of competition barriers to the client.

In the enterprise competition barrier evaluation system of the present disclosure, it is preferable that it further includes an evaluation model setting unit for setting an enterprise evaluation model for a specific type of enterprise based on a result of data analysis; and a factor setting unit for setting factors related to enterprise competition barriers for a specific type of enterprise based on a results of data analysis.

In the enterprise competition barrier evaluation system of the present disclosure, preferably, it further includes: an evaluation model generation unit, which generates an advanced evaluation model with higher accuracy based on an artificially set primary evaluation model; and a model algorithm self-learning unit which continuously optimizes the primary evaluation model or the advanced evaluation model with higher accuracy by way of machine learning, and optimizes the algorithm itself by way of machine learning; a factor generation unit, which generates advanced factors with higher accuracy based on artificially set primary factors; and a factor algorithm self-learning unit which continuously optimizes the primary factors or the advanced factors with higher accuracy by way of machine learning, and optimizes the algorithm itself by way of machine learning.

### BRIEF DESCRIPTION OF THE DRAWINGS

FIG. 1 is a schematic flow chart of a method for evaluating enterprise competition barriers involved in an embodiment of the present disclosure;

FIG. 2 is a schematic flow chart of a process for generating and optimizing an evaluation model in the method for evaluating enterprise competition barriers involved in an embodiment of the present disclosure;

FIG. 3 is a flow chart of a process for generating and optimizing factors in the method for evaluating enterprise competition barriers involved in an embodiment of the present disclosure;

FIG. 4 is a functional block diagram of the enterprise competition barrier evaluation system involved in an embodiment of the present disclosure.

### DETAILED DESCRIPTION OF THE DISCLOSURE

The specific embodiments of the present disclosure will be described below with reference to the accompanying drawings.

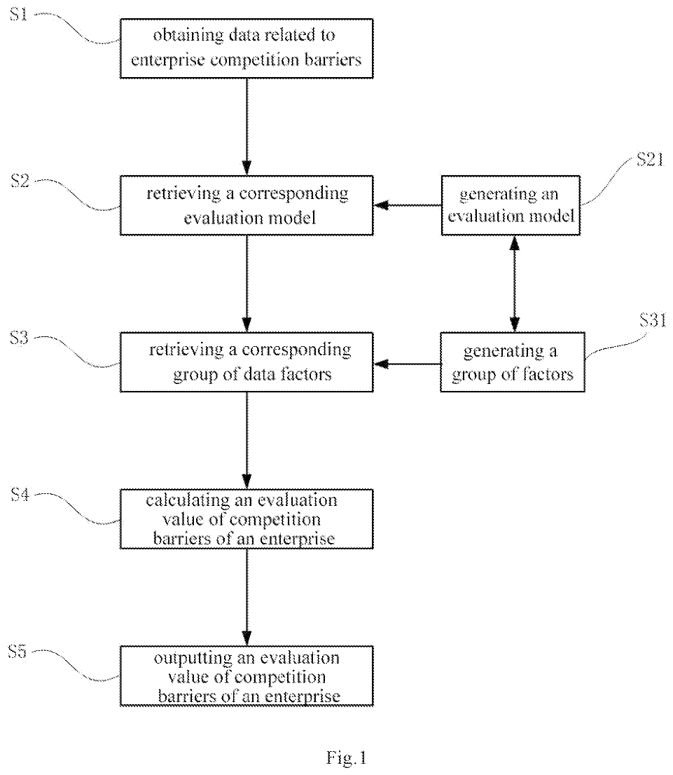

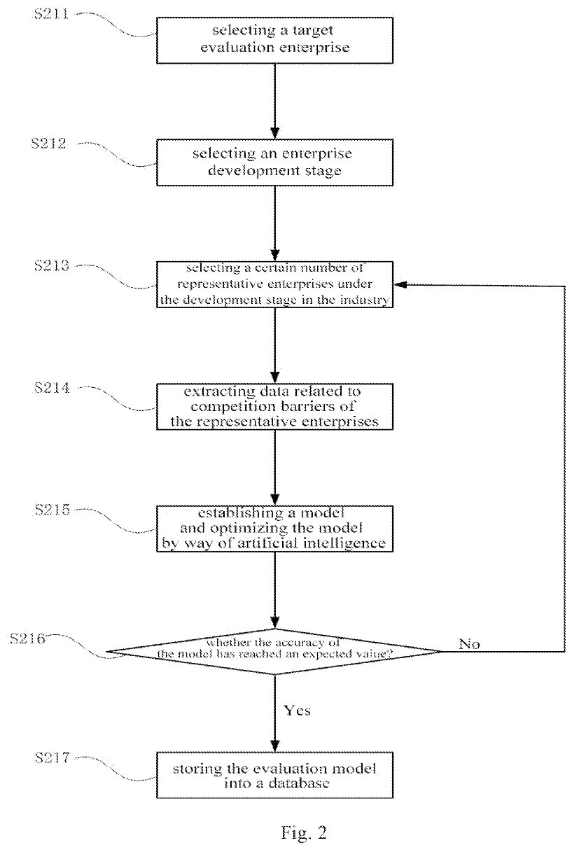

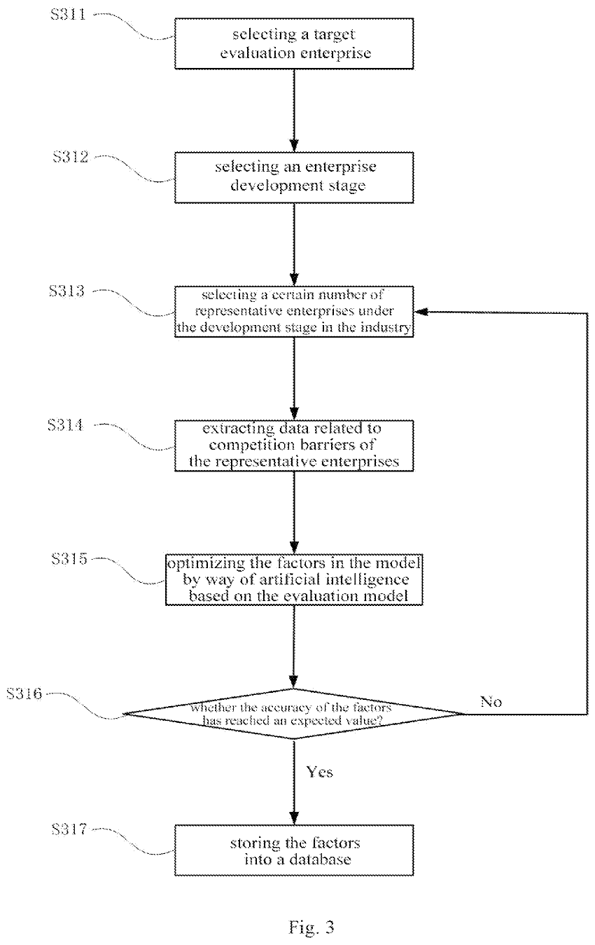

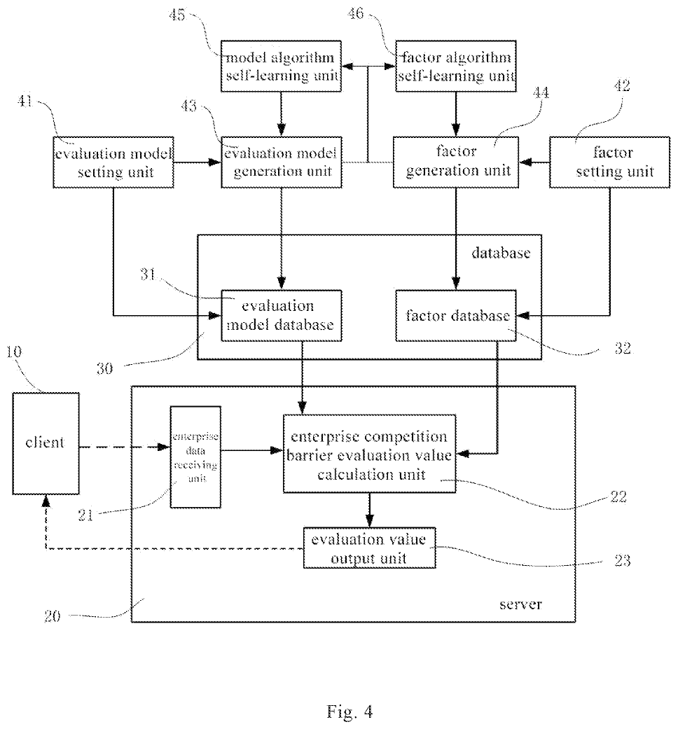

FIG. 1 is a schematic flow chart of the method for evaluating enterprise competition barriers involved in an embodiment of the present disclosure. FIG. 2 is a schematic flow chart of a process for generating and optimizing an evaluation model in the method for evaluating enterprise competition barriers involved in an embodiment of the present disclosure. FIG. 3 is a schematic flow chart of a process for generating and optimizing factors in the method for evaluating enterprise competition barriers involved in an embodiment of the present disclosure. FIG. 4 is a functional block diagram of a system for evaluating enterprise competition barriers involved in an embodiment of the present disclosure. In the method for evaluating enterprise competition barriers according to an embodiment of the present disclosure, as shown in FIGS. 1 and 4, first, in step S1, data related to enterprise competition barriers are obtained, wherein various data related to competition barriers of an enterprise to be evaluated can be entered by a user through a client 10 shown in the figure. These data related to competition barriers can be, for example, technical barrier data, team barrier data, business capability barrier data, value chain integration capability barrier data, financing capability barrier data, and goodwill and brand barrier data. An enterprise data receiving unit 21 in a server 20 receives enterprise data wirelessly or wiredly transmitted by the user through the client 10 and inputs them to an enterprise competition barrier evaluation value calculation unit 22. Of course, the user can also input a brand, name, or unified social credit code of the enterprise to be evaluated, and the server 20 uses a web crawler software to crawl (capture) public data shared by the enterprise on the internet through big data technology. The server organizes and processes the data of the enterprise to be evaluated crawled through the internet and sends them to the client 10, and the relevant data of the enterprise are displayed on a relevant application installed on the client 10, and are confirmed by the user. The user can revise and supplement these data related to enterprise competition barriers to improve evaluation effect.

Next, in step S2, an enterprise competition barrier evaluation value calculation unit 22 in the server 20 retrieves an evaluation model stored in an evaluation model database 31 for evaluating competition barriers of an enterprise. The evaluation model can be generated in step S21 and stored in the evaluation model database 31 in advance. The evaluation model pre-stored in the evaluation model database 31 can be pre-set based on an expert opinion method, or it can be a primary model generated based on mathematical statistics of a certain number of enterprises under a certain development stage in a certain industry, so that a primary modeling can be realized.

Next, in step S3, the enterprise competition barrier evaluation value calculation unit 22 in the server 20 retrieves the factors stored in the factor database 32 that correspond to the various data described above. Correspondingly, these factors are technical barrier factor, team barrier factor, business capability barrier factor, value chain integration capability barrier factor, financing capability barrier factor, and goodwill and brand barrier factor. These factors can be pre-set based on an expert opinion method in step S31, or they can be set based on statistical results of a certain number of enterprises under a certain development stage in a certain industry, and these factors are stored in the factor database 32 in advance. These factors are determined by the influence of the above various data on enterprise competition barriers.

Next, in step S4, the enterprise competition barrier evaluation value calculation unit 22 in the server 20 calculates and evaluates the competition barriers of the enterprise to be evaluated from multiple dimensions based on the retrieved evaluation model and multiple factors, so as to obtain an evaluation value of competition barriers of the enterprise to be evaluated.

As a most basic embodiment, the weight coefficients of the data related to competition barriers in each dimension can be preset as the aforementioned factors, and a weighted sum of the data related to competition barriers in all dimensions can be calculated to obtain an evaluation value of competition barriers of the enterprise.

Finally, in step S5, the competition barrier evaluation value of the enterprise to be evaluated calculated in step S4 is output to the client 10 in a manner of wireless communication or wired communication.

In the method for evaluating competition barriers of an enterprise according to the present disclosure, the technical barrier data may include, for example, the number of intellectual properties owned by the enterprise and the market value of each intellectual property. The market value of each intellectual property involves domestic potential markets and foreign potential markets. The number of the intellectual properties may include, for example, the number of granted and/or pending invention applications, utility model applications, design applications, and copyright applications. The technical barrier data may also include the number of technical secrets owned by the enterprise and the resulting market value.

In the method for evaluating competition barriers of an enterprise according to the present disclosure, the team barrier data include, for example, one or more of enterprise equity structure data, partner complementarity data, project-competence matching degree data, team innovation power data, team execution force data, and team learning power data. The team learning power data is, for example, team learning awareness data and learning ability data, and the team innovation power data may include team innovation awareness data and innovation ability data.

In the method for evaluating competition barriers of an enterprise according to the present disclosure, the business capability barrier data are, for example, one or more of special product production capability data, hardware manufacturing capability data, software development capability data, and cost control capability data.

In the aforementioned method for evaluating competition barriers of an enterprise, the value chain integration capability barrier data are, for example, one or more of purchasing capability data, marketing capability data, channel operation capability data, network influence expansion capability data, and enterprise public relations capability data.

In the method for evaluating competition barriers of an enterprise according to the present disclosure, the financing capability barrier data are, for example, financial profitability data, business plan promotion capability data, data on the breadth of financing channels, data on the ability to interact with investors, and data on the value of intangible assets.

In the method for evaluating competition barriers of an enterprise according to the present disclosure, the goodwill and brand barrier data may include, for example, brand-related trademark quantity data, trademark status data, trademark use time data, trademark spreading difficulty data, and data on network influence of the main website and data on the number of registered users, etc.

In addition, in the method for evaluating competition barriers of an enterprise of the present disclosure, the barrier data may further include, for example, enterprise cultural barrier data and enterprise value barrier data, etc.

As an embodiment of the present disclosure, existing enterprises can be classified according to industry, and/or classified according to the size of the enterprise or the financing stage. For example, enterprises can be classified according to the following industries: manufacturing, energy and minerals, new materials, environmental protection industries, agriculture, public utilities, logistics, tool software, catering, maternal and child, life services, e-commerce, automobile transportation, culture and entertainment, real estate and home furnishing, games/e-sports, animation, advertising and marketing, tourism and outdoor, sharing economy, sports, hardware, social communication, education, finance, medical and health, drones, robots, virtual reality/augmented reality (VR/AR), wholesale and retail/new retail, enterprise services, internet of things, big Data, consumption upgrade, online/offline (O2O), software-as-a-service (SaaS: Software-as-a-Service), financial payment, content industry, block chain, and artificial intelligence, etc. Enterprises can be classified into start-up period, growth period, expansion period, and mature period according to their development stages. Enterprises can also be classified into seed rounds, angel rounds, A rounds, B rounds, C rounds, D rounds, E rounds, F rounds, initial public offerings (IPOs), etc. according to the financing stages, or they can be further classified into seed rounds, angel rounds, Pre-A, A rounds, A+ rounds, Pre-B, B rounds, B+ rounds, Pre-C, C rounds, C+ rounds, Pre-D, D rounds, D+ rounds, Pre-E, E rounds, E+ rounds, Pre-F, F rounds, F+ rounds, Pre-IPO, IPO, etc.

Next, a certain number of enterprises under a certain stage of development in a certain industry are selected to artificially establish a primary evaluation model based on expert experiences with an expert opinion method, etc, and artificially set primary factors corresponding to the above-mentioned data. The expert opinion method mentioned here, specifically, can be an expert personal judgment method, an expert meeting method, the Delphi method, etc.

As another embodiment of the present disclosure, it is also possible to select a certain number of representative enterprises under a certain stage of development in the above-mentioned certain industry, and crawl massive data related to competition barriers of enterprises through the internet by virtue of big data technology, including technical barrier data, team barrier data, business capability barrier data, value chain integration capability barrier data, financing capability barrier data, and goodwill and brand barrier data, etc. Then, mathematical statistical analysis is performed on the above-mentioned data related to competition barriers of the enterprises under a certain stage of development in a target industry, and a primary evaluation model is established. Also, primary factors corresponding to the above-mentioned data are set through mathematical statistical analysis.

Regarding the establishment of the evaluation model, as shown in FIG. 2, in step S211, one of the industries listed above is selected as the target industry, and in step S213, a certain number of enterprises (for example, 500) under a certain development stage (start-up period, growth period, expansion period, and maturity period) or a certain financing stage (seed round, angel round, A round, B round, C round, D round, E round, F round, IPO) in the target industry are selected. In step S214, big data technology is used to capture or crawl data related to competition barriers of target enterprises, including technical barrier data, team barrier data, business capability barrier data, value chain integration capability barrier data, financing capability barrier data, and goodwill and brand barrier data, etc. Then, in step S215, mathematical statistical analysis is performed on the above-mentioned data related to competition barriers of the enterprises under a certain stage of development in the target industry, and a primary evaluation model, such as a weighted sum model, is established. In step S216, it is determined whether the accuracy of the evaluation model meets the requirements, and if it is determined as Yes, step S217 is entered, and the evaluation model is stored in the evaluation model database 31 of the database 30. If it is determined as No in step S216, what is performed is increasing the number of sample enterprises, returning to step S213, and repeating the process from step S213 to step S216 until the accuracy of the evaluation model reaches an expected accuracy.

Regarding the determination of the factors in the evaluation model, as shown in FIG. 3, a certain industry is selected as the target industry in step S311, and in step 313, a certain number of enterprises (for example, 500) under a certain development stage (start-up period, growth period, expansion period, and maturity period) or financing stage (seed round, angel round, A round, B round, C round, D round, E round, F round, IPO) in the target industry are selected. The target enterprises selected in step S311 and step S312 should be consistent with the target enterprises selected in step S211 and step S212. In step S314, big data technology is used to capture data related to competition barriers of the target enterprises, including technical barrier data, team barrier data, business capability barrier data, value chain integration capability barrier data, financing capability barrier data, and goodwill and brand barriers data, etc. Alternatively, in step S314, the data obtained in step S214 are directly retrieved. Then, in step S315, based on the evaluation model (such as a weighted sum model) generated in step S21, mathematical statistical analysis is performed on the above-mentioned data related to competition barriers of the enterprises under a certain stage of development in the target industry, and primary impact factors (such as weight coefficients) are determined. In step S316, it is determined whether the accuracy of the evaluation model and/or the impact factors meets the requirements, and if it is determined as Yes, step S317 is entered, and the impact factors are stored in the evaluation model database 31 of the database 30. If it is determined as No in step S316, what is performed is increasing the number of sample enterprises, returning to step S313, and repeating the process from step S313 to step S316 until the accuracy of the evaluation model reaches the expected accuracy.

The evaluation model generation/optimization process of step S211 to step S216 included in step S21 and the impact factor generation/optimization process of step S311 to step S316 included in step S31 can be performed alternately in combination with each other to obtain an evaluation model and impact factors of higher precision.

In addition, as another embodiment of the present disclosure, in order to achieve higher evaluation accuracy and efficiency, an evaluation model can be established by artificial intelligence means, and the factors can be generated by artificial intelligence means, with an algorithm with learning function, based on the obtained enterprise data. That is to say, the above-mentioned primary evaluation model and primary factors are generated by way of machine learning or deep learning and the primary evaluation model and primary factors are further optimized by way of machine learning or deep learning.

In the method for evaluating enterprise competition barriers of the present disclosure, the algorithm for optimizing the evaluation model can be optimized itself, and the algorithm for optimizing the factors can be optimized itself, through machine learning or deep learning by using neural network technology, based on successful cases in different industries and previous evaluation results. The neural network technology here can be a standard neural network, a convolutional neural network (CNN), a recurrent neural network (RNN), etc.

In the method for evaluating enterprise competition barriers of the present disclosure, one or more of the technical barrier data, the team barrier data, the business capability barrier data, the value chain integration capability data, the financing capability barrier data, and the goodwill and brand barrier data may be deleted, or new types of barrier data may be added by using artificial intelligence algorithms with learning functions to perform machine learning or deep learning based on successful cases in different industries and/or previous evaluation results.

If big data technology is used to generate and optimize the evaluation model and the impact factors through artificial intelligence, the number of samples of target enterprises can be maximized, and tens of millions of existing enterprises of various scales in various industries, whose public data can be obtained, can be analyzed, so as to continuously train and optimize the algorithm for the evaluation model and the algorithm for the impact factors.

Regarding machine learning algorithms, such as Decision Trees, Naive Bayesian classification, Ordinary Least Squares Regression, Logistic Regression, Support Vector Machine (SVM), Ensemble methods, Clustering Algorithms, PCA: Principal Component Analysis, SVD: Singular Value Decomposition, Independent Component Analysis Method (ICA), random forest method (RandomForest), etc., can be used.

Regarding deep learning models and algorithms, for example, AlexNet model, ResNet model, SGD algorithm, Adam algorithm, etc. can be used.

As shown in FIG. 4, specifically, the enterprise competition barrier evaluation system of an embodiment of the present disclosure includes a client 10, a database 30, and a server 20, wherein the database 30 has an evaluation model database 31, which stores evaluation models for enterprise competition barriers; and a factor database 32, which stores factors of various parameters related to enterprise competition barriers and groups the factors as a complete set of factors. The server 20 has an enterprise data receiving unit 21, which receives enterprise information or enterprise data input by a user from the client; an enterprise competition barrier evaluation value calculation unit 22, which retrieves a corresponding evaluation model stored in the evaluation model database and calculates a competition barrier evaluation value of an enterprise to be evaluated according to the data related to enterprise competition barriers received by the enterprise data receiving unit and the factors stored in the factor database; and an evaluation value output unit 23, which outputs the competition barrier evaluation value to the client 10.

The enterprise competition barrier evaluation system of an embodiment of the present disclosure further includes: an evaluation model setting unit 41, which sets an enterprise evaluation model for a specific type of enterprise based on a result of data analysis; and a factor setting unit 42, which sets factors related to enterprise competition barriers for a specific type of enterprise based on a result of data analysis.

The enterprise competition barrier evaluation system of an embodiment of the present disclosure further includes: an evaluation model generation unit 43, which generates an advanced evaluation model with higher accuracy according to an artificially set primary evaluation model; and a model algorithm self-learning unit 45, which continuously optimizes the primary evaluation model and the advanced evaluation model of higher accuracy as well as the algorithm itself by machine learning; a factor generation unit 44, which generates advanced factors of higher accuracy according to artificially set primary factors; and a factor algorithm self-learning unit 46, which continuously optimizes the primary factors or advanced factors of higher accuracy as well as the algorithm itself by machine learning.

1. A method for evaluating enterprise competition barriers, comprising:
a step of obtaining enterprise data, which obtains data related to enterprise competition barriers;
a step of evaluating enterprise competition barriers, which evaluates competition barriers of an enterprise to be evaluated from multiple dimensions based on an evaluation model and factors acquired in advance, so as to obtain an evaluation value of competition barriers of the enterprise to be evaluated; and
a step of outputting barrier evaluation result, which outputs the evaluation value of competition barriers of the enterprise to be evaluated.

2. The method for evaluating enterprise competition barriers according to claim 1, wherein
the data related to enterprise competition barriers include at least: technical barrier data, team barrier data, business capability barrier data, value chain integration capability barrier data, financing capability barrier data, and goodwill and brand barrier data,
the factors include a technical barrier factor, a team barrier factor, a business capability barrier factor, a value chain integration capability barrier factor, a financing capability barrier factor, and a goodwill and brand barrier factor.

3. The method for evaluating enterprise competition barriers according to claim 2, wherein:
the technical barrier data include at least the number of intellectual properties owned by the enterprise and market value of each intellectual property, and the market value of each intellectual property involves domestic potential market and foreign potential market.

4. The method for evaluating enterprise competition barriers according to claim 3, wherein:
the number of intellectual properties includes the number of granted and/or pending invention applications, utility model applications, design applications, and copyright applications.

5. The method for evaluating enterprise competition barriers according to claim 2, wherein:
the technical barrier data further includes the number of technical secrets owned by the enterprise and a resulting market value therefrom.

6. The method for evaluating enterprise competition barriers according to claim 2, wherein:
the team barrier data include at least one or more of enterprise equity structure data, partner complementarity data, project-competence matching degree data, team innovation power data, team execution force data, and team learning power data,
wherein the team learning power data include team learning awareness data and learning ability data, and the team innovation power data include team innovation awareness data and innovation ability data.

7. The method for evaluating enterprise competition barriers according to claim 2, wherein:
the business capability barrier data include at least one or more of special product production capability data, hardware manufacturing capability data, software development capability data, and cost control capability data.

8. The method for evaluating enterprise competition barriers according to claim 2, wherein:
the value chain integration capability barrier data include at least one or more of purchasing capability data, marketing capability data, channel operation capability data, network influence expansion capability data, and enterprise public relations capability data.

9. The method for evaluating enterprise competition barriers according to claim 2, wherein:
the financing capability barrier data include at least financial profitability data, business plan promotion capability data, data on the breadth of financing channels, data on the ability to interact with investors, and data on the value of intangible assets.

10. The method for evaluating enterprise competition barriers according to claim 2, wherein:
the goodwill and brand barrier data include at least brand-related trademark quantity data, trademark status data, trademark use time data, trademark spreading difficulty data, main website influence data, and data on the number of registered users.

11. The method for evaluating enterprise competition barriers according to claim 2, wherein:
the barrier data further includes enterprise cultural barrier data and enterprise value barrier data.

12. The method for evaluating enterprise competition barriers according to claim 2, wherein in the step of obtaining enterprise data,
a user directly enters data related to competition barriers of the enterprise to be evaluated, or
an evaluation server uses big data technology to crawl public data shared by the enterprise through the internet based on a brand, name, or unified social credit code entered by a user.

13. The method for evaluating enterprise competition barriers according to claim 2, wherein:
the evaluation model and/or each factor are preset according to a development stage of the enterprise and an industry to which it belongs, and adjusted artificially according to a result of statistical analysis, or optimized based on artificial intelligence.

14. The method for evaluating enterprise competition barriers according to claim 13, wherein:
each factor is set in advance as a weight coefficient of competition barrier-related data of each dimension, and a weighted sum of the competition barrier-related data of all dimensions is calculated as the evaluation value of competition barriers of the enterprise.

15. The method for evaluating enterprise competition barriers according to claim 2, wherein:
an artificial intelligence algorithm with a learning function is used to generate and continuously optimize the evaluation model and a combination of the factors through machine learning or deep learning based on successful cases in different industries and previous evaluation results.

16. The method for evaluating enterprise competition barriers according to claim 15, wherein:
an algorithm for generating the evaluation model and/or an algorithm for generating the factors are optimized through machine learning or deep learning based on successful cases in different industries and previous evaluation results.

17. The method for evaluating enterprise competition barriers according to claim 2, wherein:
an artificial intelligence algorithm with a learning function is used to delete barrier data from or add new types of barrier data to one or more of the technical barrier data, the team barrier data, the business capability barrier data, the value chain integration capability barrier data, the financing capability barrier data, and the goodwill and brand barrier data, through machine learning or deep learning based on successful cases in different industries and/or previous evaluation results.

18. A system for evaluating enterprise competition barriers, which evaluates competition barriers of an enterprise by using the method for evaluating enterprise competition barriers according to claim 1, the system comprising a client, a database and a server, wherein:
the database comprises:
an evaluation model database, which stores evaluation models for enterprise competition barriers; and
a factor database, which stores factors of various parameters related to enterprise competition barriers, and groups the factors as a set of factors;
the server comprises:
an enterprise data receiving unit that receives enterprise information or enterprise data input by a user from the client;
an enterprise competition barrier evaluation value calculation unit that retrieves a corresponding evaluation model stored in the evaluation model database, and calculates the evaluation value of competition barriers of the enterprise to be evaluated based on the data related to competition barriers of the enterprise received by the enterprise data receiving unit and the factors stored in the factor database; and
an evaluation value output unit, which outputs the evaluation value of competition barriers to the client.

19. The system for evaluating enterprise competition barriers according to claim 18, further comprising:
an evaluation model setting unit for setting an enterprise evaluation model for a specific type of enterprise based on a result of data analysis; and
a factor setting unit for setting factors related to enterprise competition barriers for a specific type of enterprise based on a results of data analysis.

20. The system for evaluating enterprise competition barriers according to claim 18, further comprising:
an evaluation model generation unit, which generates an advanced evaluation model with higher accuracy based on an artificially-set primary evaluation model;
a model algorithm self-learning unit, which continuously optimizes the primary evaluation model or the advanced evaluation model with higher accuracy by way of machine learning, and optimizes an algorithm itself by way of machine learning;
a factor generation unit, which generates advanced factors with higher accuracy based on artificially-set primary factors; and
a factor algorithm self-learning unit, which continuously optimizes the primary factors or the advanced factors with higher accuracy by way of machine learning, and optimizes an algorithm itself by way of machine learning.
